(19) United States
(12) Patent Application Publication
(10) Pub. No.: US 2012/0303934 A1
(43) Pub. Date: Nov. 29, 2012

(54) METHOD AND APPARATUS FOR GENERATING AN ENHANCED PROCESSOR RESYNC INDICATOR SIGNAL USING HASH FUNCTIONS AND A LOAD TRACKING UNIT

(75) Inventor: David A. Kaplan, Austin, TX (US)

(73) Assignee: ADVANCED MICRO DEVICES, INC., Sunnyvale, CA (US)

(21) Appl. No.: 13/116,414

(22) Filed: May 26, 2011

(51) Int. Cl. G06F 9/312

(52) U.S. Cl. 712/205; 712/E09.033

(57) ABSTRACT

A method and apparatus are described for generating a signal to resync a processor. In one embodiment, a particular load operation is picked from a load queue in the processor, and the particular load operation is completed out of order with respect to other load operations in the load queue. A load ordering block (LOB) in the processor receives a physical address of the completed load operation, and receives a probe data address that indicates an address of a requested data line. The LOB generates a signal to resync the processor when the physical address of the completed load operation matches the probe data address, (i.e., when bits, that have been set in a bit vector (e.g., Bloom filter) of the LOB by hashing the physical address of the completed load operation, match bits generated by hashing the probe data address).

### FIELD OF INVENTION

This application is related to the design of a processor. More particularly, this application is related to using hash functions and at least one bit vector, (e.g., Bloom filter), to generate an enhanced processor resync indicator signal.

### BACKGROUND

X86 processors define a relatively strict memory ordering model, which includes rules for load-load ordering. Specifically, loads cannot appear to pass previous (i.e., older) loads. In a high performance processor however, it may be desirable for loads to be executed out of order, in which case the processor must include logic for ensuring that no ordering rules are violated. For example, from the point of a program running on an X86 processor, all stores, loads and input/output (I/O) operations from a single processor appear to occur in program order to the code running on the processor, and all instructions appear to execute in program order. In this context, loads do not pass previous loads, (i.e., loads are not re-ordered), and stores do not pass previous stores, (i.e., stores are not re-ordered).

As shown in Table 1 below, after all memory values are initialized to zero, store memory location A (store A) is updated with a logic one, and then store memory location B (store B) is updated with a logic one, because stores do not pass previous (i.e., older) stores. It would not be “legal” for store B to be updated before store A is updated, because store A is older than store B.

TABLE 1

| Processor 0 | Processor 1 |
|---|---|
| Store A ← 1 | Load B |
| Store B ← 1 | Load A |

Since loads do not pass previous (i.e., older) loads, Load A in Table 1 must be executed after Load B, and Load A cannot read a logic zero when Load B reads a logic one (i.e., representing the new data).

There are several known techniques to enforce load ordering. For example, when loads become non-speculative, they may be re-executed to check that the data is the same as the last time. This is very costly for power, as well as performance and requires very large queues. In another example, if a load has completed out of order with respect to another load, probes from another processor to the same address as the load must be monitored. If a probe comes in that matches the line for a load that has been performed out of order, the pipeline must be flushed and the load is re-executed. Unfortunately, this may require a very large load queue in order to provide sufficient capacity to process instructions at an acceptable rate, which costs silicon area.

One known solution is to place the load in a special queue. If the load completed out of order, it is added to the special queue that includes some basic age information and part (or all) of the address to use for checking against probes. This special queue may be smaller in width (bits-per-entry) than the load queue, but still adds significant silicon area and complexity of having two structures. Furthermore, in order to minimize the silicon area, a subset of matching address bits may be maintained without the entire respective physical addresses matching, which introduces false resyncs.

### SUMMARY OF EMBODIMENTS

A method and apparatus are described for generating a signal to resync a processor. In one embodiment, a particular load operation (Op) is picked from a load queue in the processor, and the particular load Op is completed out of order with respect to other load Ops in the load queue. A load ordering block (LOB) in the processor receives a physical address of the completed load Op, and receives a probe data address that indicates an address of a requested data line. The LOB generates a signal to resync the processor when the physical address of the completed load Op matches the probe data address.

The LOB may include at least one bit vector (e.g., Bloom filter). A plurality of bits may be set in the bit vector by hashing the physical address of the completed load Op. The LOB may generate the signal to resync the processor when bits that have been set in the bit vector match bits generated by hashing the probe data address.

The LOB may comprise a plurality of load tracking units. Each load tracking unit may include a respective bit vector. The LOB may select a particular one of the load tracking units, and add the completed load Op to the respective bit vector in the selected load tracking unit.

Each of the load tracking units may include a counter that keeps track of the number of load Ops added to the respective bit vector. The selection of the particular load tracking unit may be based on the number of load Ops indicated by the counters. The counter may indicate that the number of load Ops added to the respective bit vector has reached a threshold. Picks of load Ops from the load queue may be stalled in response to the threshold being reached.

Each of the load tracking units may include an age register that keeps track of the age of the load Ops added to the respective bit vectors. The age register may be cleared, and the entries of the respective bit vector in a particular one of the load tracking units may be invalidated when the age register in the particular load tracking units indicates that all older load Ops have completed.

The age register may be implemented as a bit vector or a timestamp. In another embodiment, a computer-readable storage medium may be configured to store a set of instructions used for manufacturing a semiconductor device. The semiconductor device may comprise a load queue configured to store load operations (Ops), and an LOB. The LOB may comprise a first logic unit configured to receive load completion information that indicates that a particular load Op was picked from the load queue and completed out of order with respect to other load Ops in the load queue. The LOB may further comprise a second logic unit configured to receive a physical address of the completed load Op. The LOB may further comprise a third logic unit configured to receive a probe data address that indicates an address of a requested data line, and generate a signal to resync the processor when the physical address of the completed load Op matches the probe data address. The instructions may include Verilog data instructions or hardware description language (HDL) instructions.

### BRIEF DESCRIPTION OF THE DRAWINGS

A more detailed understanding may be had from the following description, given by way of example in conjunction with the accompanying drawings wherein:

FIG. 1 shows a block diagram of a pipeline of a processor including a LOB configured in accordance with one embodiment of the present invention;

FIG. 2 shows an example block diagram of the LOB of FIG. 1;

FIG. 3 shows a block diagram of a hash function bit set logic unit in the LOB of FIG. 2; and

FIG. 4 shows a block diagram of a hash function bit check logic unit in the LOB of FIG. 2.

### DETAILED DESCRIPTION

A load ordering block (LOB) is a structure used to enforce X86 processor memory ordering for cacheable loads executed out of order. Its purpose is to ensure that loads obtain consistent results and, if necessary, to resync the processor, (i.e., flush the pipeline and refetch the next instruction), to re-execute loads. The LOB enforces the load ordering in accordance with predefined rules that require that loads do not appear to pass older loads.

The LOB operates on the principle that, if a data line is present in the cache in a writeable state, no other core may be writing the data. Once a data line is no longer present in a data cache (DC) in a writeable state, no guarantees can be made. Therefore, when the DC either invalidates or downgrades a line, the LOB is checked and, if a load matching that address has completed out of order, a resync is signaled. This resync is not taken on the load that completed out of order, (which has already completed), but is instead taken on the oldest load still outstanding in a load/store unit (LSU).

When loads complete out of order, they must be added to the LOB. When loads are added, they track which older loads they bypassed. Once those older loads have executed, the added load no longer must be protected by the LOB. This is because, assuming that no probe has occurred to cause a resync until this time, the out-of-order execution is now safe because the loads appeared to execute in program order.

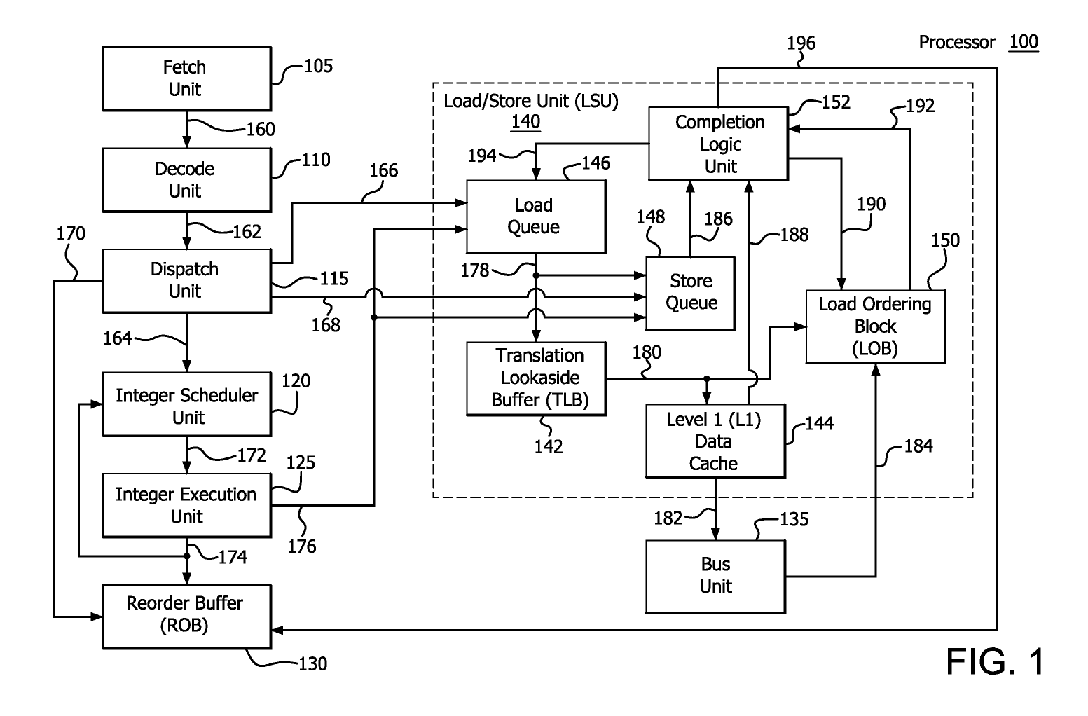

FIG. 1 shows a block diagram of a pipeline of a processor 100 configured in accordance with an embodiment of the present invention. The processor 100 includes a fetch unit 105, a decode unit 110, a dispatch unit 115, an integer scheduler unit 120, an integer execution unit 125, a reorder buffer (ROB) 130, a bus unit 135 and a load/store unit (LSU) 140. The LSU 140 includes a translation lookaside buffer (TLB) 142, a level 1 (L1) data cache 144, a load queue 146, a store queue 148, a load ordering block (LOB) 150 and a completion logic unit 152.

Referring to FIG. 1, the fetch unit 105 fetches instruction bytes from an instruction cache (not shown). The fetch unit 105 forwards the instruction bytes 160 to the decode unit 110, which breaks up the instruction bytes 160 into individual decoded instructions 162, which are then forwarded to the dispatch unit 115. The dispatch unit 115 forwards integer-based operations (Ops) 164 to the integer scheduler unit 120, load Ops 166 to the load queue 146, store Ops to the store queue 148, and Ops 170 to the ROB 130.

Once an integer-based Op 164 is ready for execution, the integer scheduler unit 120 forwards an Op 172 to the integer execution unit 125, wherein the Op 172 is executed, and Op completion information 174, (i.e., results of an arithmetic or logical operation), is provided to the ROB 130 and the integer scheduler unit 120. The integer execution unit 125 also provides address information 176 to the load queue 146 and the store queue 148. The load queue 146 writes the load Ops 166 into an internal queue (not shown) and waits until they are ready to be executed, after receiving the appropriate address information 176 from the integer execution unit 125. The store queue 148 writes the store Ops 168 into an internal queue (not shown) and waits until they are ready to be executed, after receiving the appropriate address information 176 from the integer execution unit 174.

The load queue 146 outputs picked load linear address information 178 to the TLB 142 each time a load Op is picked for execution. The TLB 142 then outputs a corresponding completion load physical address 180 to the L1 data cache 144 and the LOB 150. In response to receiving the completion load physical address 180, the 1 data cache 144 determines whether there is a cache data line that corresponds to the completion load physical address 180 and outputs a cache hit/miss signal 182 to the bus unit 135 that either indicates that there is a corresponding data line (hit) or there is not a corresponding data line (miss). The bus unit 135 outputs probe information, (i.e., the physical address of data being requested, type of probe used), 184 to the LOB 150 if the cache hit/miss signal 182 indicates that there is a corresponding data line (hit). The completion logic unit 152 receives older store conflict information 186 from the store queue 186, which determines whether there is an older store that conflicts with the data address. The completion logic unit 152 also receives cache hit/miss information 188 from the L1 data cache 144 for the load Op picked for execution.

The completion logic unit 152 outputs load completion information 190 to the LOB 150 for load Ops that have been successfully completed. The LOB 150 outputs a resync indicator signal 192, which tells the completion logic unit 152 to resync on the next load completion. The completion logic unit 152 sends a signal 194 to the load queue 146 to delete completed loads, and sends load/store completion information 196 to the ROB 130.

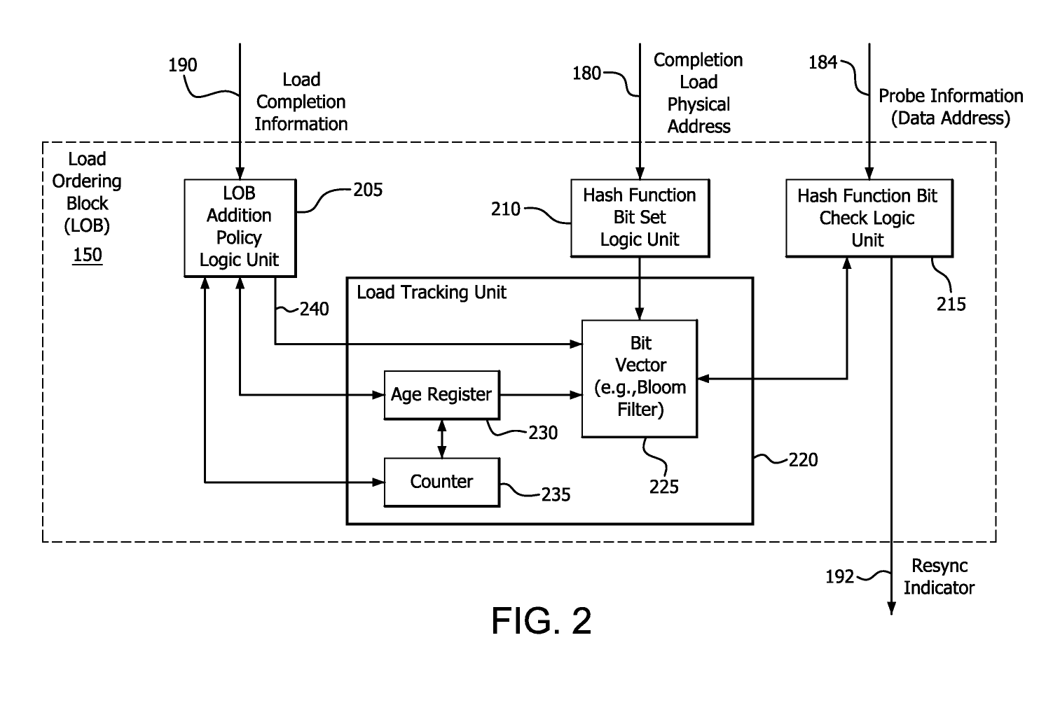

FIG. 2 shows an example block diagram of the LOB 150 of FIG. 1. The LOB 150 may include a LOB addition policy logic unit 205, a hash function bit set logic unit 210, a hash function bit check logic unit 215 and at least one load tracking unit 220. The LOB 150 is responsible for enforcing load-load ordering rules.

In accordance with an embodiment of the present invention, the LOB 150 may include a plurality of identical load tracking units 220, each including a bit vector 225, an age register 230 and a counter 235.

After being dispatched into the load queue 146, load Ops can be issued for execution. Upon issue, they are sent to the TLB 142 and the L1 data cache 144, and the completion logic unit 152 determines whether the load Ops can complete or not. Conflicts from the store queue 148 may also used in this computation. If the load Op can complete, load store completion information (including data and a ROB tag) is sent to the ROB 130, and some of the information is sent to the LOB 150 in order to be added to a bit vector 225 in the LOB 150 if the load Op completed out-of-order.

The bit vector 225 may be, for example, a Bloom filter of any desired size, (e.g., a B-bit wide flop array), which is a space-efficient probabilistic data structure that is used to test whether an element is a member of a set. False positives are possible, but false negatives are not. A false positive may cause the processor 100 to create an unnecessary resync, causing no functional issue but degrading performance, (i.e., an acceptable false positive rate as long as the extra resyncs are not noticeable). Elements may be added to the filter, but not removed. The more elements that are added to the filter, the larger the probability of false positives. An empty bit vector is a bit array of B bits, all set to zero.

When an element is to be added to the bit vector 225, the element is put through multiple hash functions. Each hash function will return a bit to set in the bit vector. To add the element to the bit vector 225, each bit indicated will be set. Checking the bit vector 225 for an element is performed in a similar manner, whereby the element is put through the same hashing functions, and the bit at each location indicated is checked. If all locations return a 1, the element is said to be in the bit vector 225.

The age register 230 holds age information about the load Ops added to the load bit vector 225, and the counter 235 keeps track of (i.e., counts) how many load Ops have been added to the bit vector 225. For example, the age register may be implemented as a bit vector or as a timestamp to track which loads in the load queue 146 are older than entries in the bit vector 225.

The LOB addition policy logic unit 205 is configured to receive load completion information 190 that indicates whether or not a particular load Op was picked, (i.e., issued, selected for execution), and completed out of order with respect to other loads, (i.e., the particular load Op was picked before other “older” load Ops stored in the load queue 146). If the load Op was completed out of order, the LOB addition policy logic unit 205 is configured to determine whether to add the out-of-order load Op to the bit vector 225 in the load tracking unit 220, and outputs a select logic value via output path 240 indicating whether the out-of-order load Op should be added to the bit vector 225.

In general, the LOB 150 may be defined by the number, N, of load tracking units 220; the size, M, of each bit vector 225, (i.e., how many loads can be added); and the acceptable false positive rate, P, for the bit vector 225 (upper bound). Under the assumption that the bit vector 225 is a Bloom filter, the necessary width B of the bit vector 225 may be calculated based on M and P using the following known formula for Bloom filter capacity:

$$B = \frac{- ( M \times ln ( P ) )}{{( ln ( 2 ) )}^{2}} , \qquad Equation ( 1 )$$

where ln is the natural logarithm.

The bit vector 225 may use multiple hash functions to reduce the probability of false positives. Each hash function may indicate a bit to set or check, and the number of hash functions is related to the parameters above. The number of hash functions needed may be defined as K, and it is computed as follows:

$$K = \frac{B \times ln ( 2 )}{M} . \qquad Equation ( 2 )$$

K different hash functions, called Hᵢ(X), are defined as a hash function where i=1 . . . K. Hᵢ(X) takes as input a physical address, (width defined by processor architecture), and outputs a number in the range [0, 2^{B}−1]. These hash functions may be defined in any manner, but should be independent and have good hashing characteristics to avoid collisions.

The Equations (1) and (2) shown above calculate the “ideal” values of B and K. In an actual implementation however, these values are not strictly constrained to those formulas as certain values, (e.g., B being a power of 2), may make implementation simpler.

The false positive rate r_{fp} of the bit vector 225 is:

$${r}_{fp} = {( 1 - {e}^{( \frac{- K \times M}{B} )} )}^{K} . \qquad Equation ( 3 )$$

The value of K and B minimize this probability. However, more implementation-friendly values may be chosen as long as the false positive rate, (as computed by Equation (3)), remains acceptable.

As mentioned above, the hash functions Hᵢ(X) should be independent and have good hashing characteristics. Functions from the class H3 are good choices, although others are possible as well. H3 hash functions are defined as follows: To hash a Q-bit wide number into the range [0, 2^{P}−1], a random binary matrix y is selected with the dimensions P×Q, where H(x) is computed as:

H(x)=(x₁·y₁)⊕(x₂·y₂) . . . ⊕(x_{Q}·y_{Q})), Equation (4)

where x₁ is bit 1 in x, x₂ is bit 2 in x, . . . , x_{Q} is bit Q in x; and y₁ is the first row of the random binary matrix, y₂ is the second row of the random binary matrix, . . . , and y_{Q} is the row Q of the random binary matrix y. Thus, each row of the matrix y is AND'd with the appropriate bit from the number x to be hashed. Then, all of the rows are XOR'd together.

When a new load completes out-of-order, the following procedure takes place to add the load to the LOB 150. First, a load tracking unit 220 is picked for adding based on a defined policy. The defined policy may have many different forms. One such policy may require that the bit vector 225 in each load tracking unit 220 be filled in a predetermined order. Other policies are possible as well, including trying to balance the bit vectors 225 and increment their age registers 230 by as little as possible.

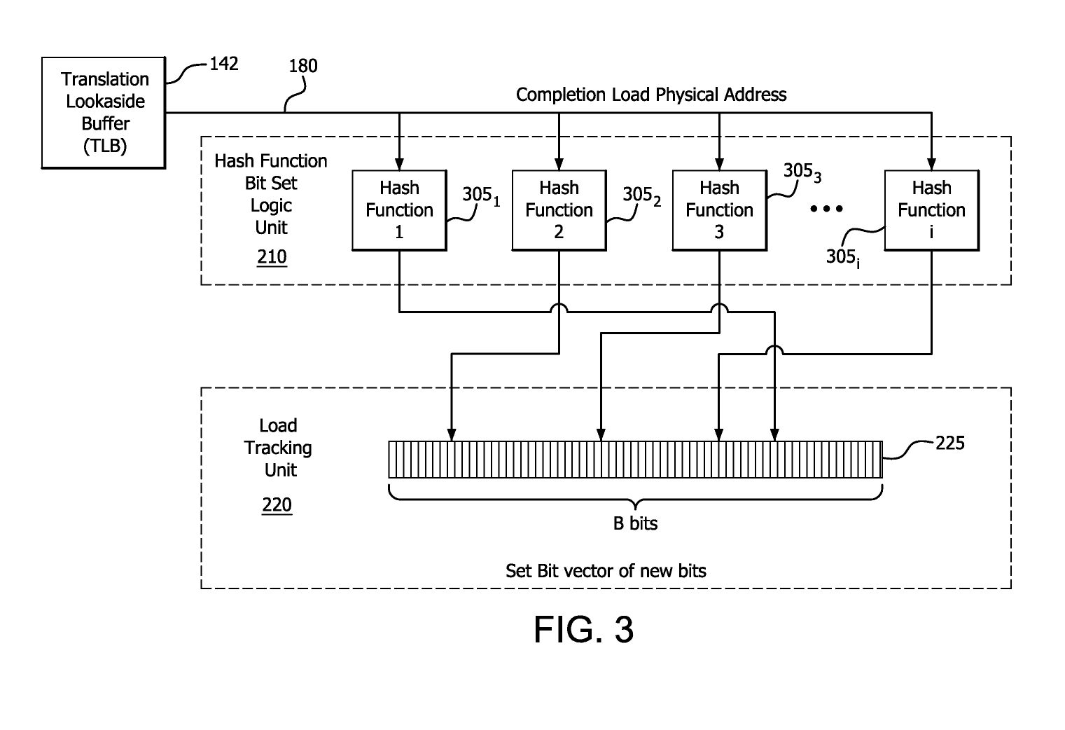

FIG. 3 shows a block diagram of the hash function bit set logic unit 210 in the LOB 150 of FIG. 2. As shown in FIGS. 2 and 3, the hash function bit set logic unit 210 is configured to receive the completion load physical address 180 from the TLB 142. The hash function bit set logic unit 210 includes a plurality of i hash functions 305₁-305ᵢ, each of which maps or hashes some set element to one of the m array positions with a uniform random distribution. To add an element, the element is fed to each of the i hash functions to get i array positions. The bits at all these positions are set to 1.

For each hash function Hᵢ where i=1 . . . K, a selected bit position L to be set in the bit vector 225 of the load tracking unit 220, is computed as L=Hᵢ, where 0≦L≦2^{B}−1, and the age register 230 and counter 235 in the load tracking unit 220 is updated as needed to reflect the newly added load. Each hash function may contain a random binary matrix having P×Q bits, where P is the bit width of the completion load physical address 180. Each bit of the load's physical address is AND'd with a row from the matrix, and then all of the rows are XOR'd together to form the hash result. After getting the result from the hash function, the value is decoded into a one-hot vector that is OR'd with the bit vector 225 in order to add the entry to the bit vector 225.

Each bit vector 225 may have a fixed size associated with it. Once the load capacity of the bit vector 225 has been reached, it can no longer accept new loads. In one embodiment, the addition policy may be used to add to a bit vector 225 until it fills up, and then to add to a next bit vector 225, and so on. The LOB 150 may start hashing the address a cycle before the addition policy is implemented. Thus, for example, hashing may start in a first cycle for a load, and finish in a second cycle, when the resulting bits are then added to the bit vector 225.

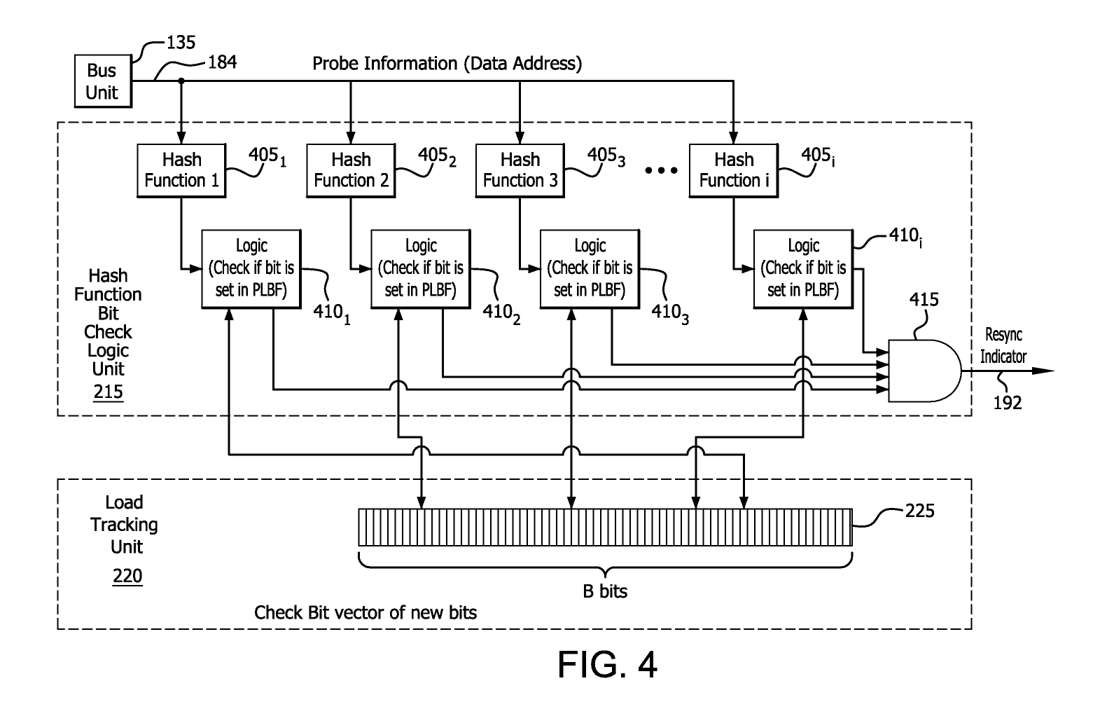

When a probe is sent to the LOB 150, each bit vector 225 may be checked to see if there is a match with the probe address. This may be performed by putting the probe address through the same set of hashing functions as an LOB add. Each bit vector 225 may then be checked to see if it has all of the bits set in its filter, and if so, signals a match. The LOB 150 does not need to be checked in a single cycle. The check may be performed over several cycles using a state machine. As shown in FIG. 4, when there are i hash functions, i bit locations must be checked. When a probe occurs, all of the bit vectors 225 are checked for a possible hit.

There is the possibility that a probe could occur for a line as a load is being added to the LOB 150. Because of this, a completing load's address is compared fully against the victim address in the first cycle. If a probe is going on at this time, the LOB 150 may issue a resync indicator signal 192 to ensure that a required resync is not missed.

If there are a plurality of load tracking units 220 used in the LOB 150, there may also be a plurality of respective output paths 240 connected between the LOB addition policy logic unit 205 and each bit vector 225 of the load tracking units 220. The LOB addition policy logic unit 205 may be configured to further determine which of the bit vector 225 the out-of-order load Op should be added to. A select logic value may be sent over a selected output path 240 to the respective bit vector 225 that is to take the out-of-order load Op. The load tracking unit 220 is further configured to update its respective bit vector 225, age register 230 and counter 235 in response to adding the out-of-order load Op.

Completed out-of-order load Ops go through a hash function and are added to the bit vector 225 selected by the LOB addition policy logic unit 205. Probes also go through a set of hash functions in order to look for a hit in the bit vectors 225. If a hit is detected, this information is fed back into the completion logic unit 152, causing any future out-of-order load Ops to be tagged with a resync. This resync will later cause a pipeline flush in order to re-execute the load Op that was executed out-of-order, at which point it is no longer necessary to tag load Ops as needing a resync.

FIG. 4 shows a block diagram of the hash function bit check logic unit 215 in the LOB 150 of FIG. 2. As shown in FIGS. 2 and 4, the hash function bit check logic unit 215 is configured to receive the probe information (data address) 184 from the bus unit 135. The hash function bit check logic unit 215 includes a plurality of hash functions 405₁-405ᵢ and a plurality of logic units 410₁-410ᵢ used to check the set bits in each bit vector 225 for a match with the probe data address 184 by hashing the probe data address i times, and checking whether each bit generated by the hashing has been set in the bit vector 225. If this is the case, the resync indicator signal 192 indicates to the ROB 130 that a resync is necessary.

The hash function bit check logic unit 215 also includes an AND gate 415 to combine the outputs of each of the logic units 410₀-410ᵢ to generate the resync indicator signal 192. In the case where a plurality of load tracking units 220 are used, additional logic units 410 and AND gates 415 may be used to check whether the bits of the other bit vectors 225 in the load tracking units 220 are set, and the outputs of the AND gates 415 may be OR'd together to generate the resync indicator signal 192.

When the probe information 184 is received by the LOB 150, the entire LOB 150 is checked by the hash function bit check logic unit 215 to determine whether the processor 100 needs to be resynced.

Once all older loads have completed, an out-of-order load no longer needs protection provided by the LOB 150. However, loads cannot be individually deleted from the bit vector 225. Instead, once every load Op in the bit vector 225 is no longer speculative, the entire bit vector 225, the age register 230 and the counter 235 may be cleared.

In one embodiment, when load Ops complete, the position of the completing load Op within the load queue 146 may be sent to the LOB 150, which then clears the corresponding bit from each age register 230 in each load tracking unit 220. If the result is that the age registers 230 are all zero, the entries in the bit vector 225 may be invalidated. When this happens, the counter 235 is reset to zero, and the bit vector 225 is cleared. Alternatively, the age registers 230 may be timestamps.

There are two ways that entries may be invalidated in the LOB 150. The first is on a pipeline flush. Since all loads being protected in the LOB 150 are considered speculative, a pipeline flush will clear out the bit vectors 225, (setting them to zero), and reset the count fields of the counters 235 to zero. The second way to invalidate entries of the bit vector 235 is through load Op completion, as described above. Thus, entries in the LOB 150 may only be released in M-size chunks.

Although the bit vectors 225 have no fixed limit, exceeding the capacity of a bit vector 225 by adding too many load Ops will cause the false positive rate p to go up. Therefore, once the bit vectors 225 in the LOB 150 start to fill up, it may be desirable to start stalling load picks in the LSU 140 in order to avoid overflowing the LOB 150. The LOB 150 may avoid overflowing by maintaining a global count, by summing the counts of the counter 235 in each load tracking unit 220, (or otherwise computing it), and when that approaches the design limit, asserting a stall signal to the load queue 146. Because of pipeline delays, that stall signal may need to be asserted before the LOB 150 is entirely full.

Because the bit vectors 225 require less bits of storage per entry as compared to storing a full address, the size of the LOB 150 may be much smaller than a conventional structure. In accordance with the present invention, either the silicon area of the processor 100 may be improved by replacing a load-ordering structure with this smaller structure, or performance may be improved by using the same amount of silicon area to store more load Ops, thus providing sufficient capacity to process instructions at an acceptable rate.

Although features and elements are described above in particular combinations, each feature or element can be used alone without the other features and elements or in various combinations with or without other features and elements. The apparatus described herein may be manufactured using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A method of generating a signal to resync a processor, the method comprising:
picking a particular load operation from a load queue in the processor and completing the particular load operation out of order with respect to other load operations in the load queue;
a load ordering block (LOB) in the processor receiving a physical address of the completed load operation;
the LOB receiving a probe data address that indicates an address of a requested data line; and
the LOB generating a signal to resync the processor when the physical address of the completed load operation matches the probe data address.

2. The method of claim 1 wherein the LOB includes at least one bit vector, the method further comprising:
setting a plurality of bits in the bit vector by hashing the physical address of the completed load operation.

3. The method of claim 2 wherein the LOB generates the signal to resync the processor when bits that have been set in the bit vector match bits generated by hashing the probe data address.

4. The method of claim 1 wherein the LOB comprises a plurality of load tracking units, each load tracking unit including a respective bit vector, the method further comprising:
the LOB selecting a particular one of the load tracking units; and
the LOB adding the completed load operation to the respective bit vector in the selected load tracking unit.

5. The method of claim 4 wherein each of the load tracking units includes a counter that keeps track of the number of load operations added to the respective bit vector, and the selection of the particular load tracking unit is based on the number of load operations indicated by the counters.

6. The method of claim 5 further comprising:
the counter indicating that the number of load operations added to the respective bit vector has reached a threshold; and
stalling picks of load operations from the load queue in response to the threshold being reached.

7. The method of claim 4 wherein each of the load tracking units includes an age register that keeps track of the age of the load operations added to the respective bit vector.

8. The method of claim 7 further comprising:
clearing the age register and invalidating the entries of the respective bit vector in a particular one of the load tracking units when the age register in the particular load tracking unit indicates that all older load operations have completed.

9. The method of claim 7 wherein the age register is implemented as a bit vector or a timestamp.

10. The method of claim 1 wherein the bit vector is a Bloom filter.

11. A processor comprising:
a load queue configured to store load operations; and
a load ordering block (LOB) comprising:
a first logic unit configured to receive load completion information that indicates that a particular load operation was picked from the load queue and completed out of order with respect to other load operations in the load queue;
a second logic unit configured to receive a physical address of the completed load operation; and
a third logic unit configured to receive a probe data address that indicates an address of a requested data line, and generate a signal to resync the processor when the physical address of the completed load operation matches the probe data address.

12. The processor of claim 11 further comprising:
at least one load tracking unit including a bit vector, wherein the second logic unit is further configured to set a plurality of bits in the bit vector by hashing the physical address of the completed load operation.

13. The processor of claim 12 wherein the third logic unit is further configured to generate the signal to resync the processor when bits that have been set in the bit vector match bits generated by hashing the probe data address.

14. The processor of claim 11 wherein the bit vector is a Bloom filter.

15. The processor of claim 11 wherein the load tracking unit further includes:
a counter that keeps track of the number of load operations added to the bit vector; and
an age register that keeps track of the age of the load operations added to the bit vector.

16. The processor of claim 15 wherein picks of load operations from the load queue are stalled in response to the counter indicating that the number of load operations added to the bit vector has reached a threshold.

17. The processor of claim 15 wherein the age register is implemented as a bit vector or a timestamp.

18. The processor of claim 15 wherein the LOB comprises a plurality of load tracking units, each load tracking unit including a respective counter, and the LOB selects a particular one of the load tracking units based on based on the number of load operations indicated by the counters.

19. A computer-readable storage medium configured to store a set of instructions used for manufacturing a semiconductor device, wherein the semiconductor device comprises:
a load queue configured to store load operations; and
a load ordering block (LOB) comprising:
a first logic unit configured to receive load completion information that indicates that a particular load operation was picked from the load queue and completed out of order with respect to other load operations in the load queue;
a second logic unit configured to receive a physical address of the completed load operation; and
a third logic unit configured to receive a probe data address that indicates an address of a requested data line, and generate a signal to resync the processor when the physical address of the completed load operation matches the probe data address.

20. The computer-readable storage medium of claim 19 wherein the instructions are Verilog data instructions.

21. The computer-readable storage medium of claim 19 wherein the instructions are hardware description language (HDL) instructions.
